(19) United States
(12) Patent Application Publication
(10) Pub. No.: US 2026/0356502 A1
(43) Pub. Date: Nov. 12, 2026

(54) MICROTHRUSTER ARRAY

(71) Applicant: The Charles Stark Draper Laboratory, Inc., Cambridge, MA (US)

(72) Inventor: Carlos Rodriguez, Cambridge, MA (US)

(21) Appl. No.: 19/515,673

(22) PCT Filed: Aug. 30, 2024
(86) PCT No.: PCT/US2024/044693

§ 371 Date: Mar. 2, 2026

Related U.S. Application Data
(60) Provisional application No. 63/580,790, filed on Sep. 6, 2023.

(51) Int. Cl. B64G 1/26; F02K 9/97

(52) U.S. Cl. CPC B64G 1/26; F02K 9/97; F05D 2250/82

(57) ABSTRACT

A microthruster array system may include a package housing configured to receive circuitry and a propellant housing, a nozzle plate configured to close the package housing and ensure element ignition, the propellant housing arranged between the nozzle and the package housing and configured to house propellant for use in propulsion of the microthruster, and wherein the nozzle plate defines a plurality of openings for controlling a flow of the propellant during propulsion.

### CROSS-REFERENCE TO RELATED APPLICATIONS

This application claims the benefit of U.S. provisional application Ser. No. 63/580,790 filed Sep. 6, 2023, the disclosure(s) of which is(are) hereby incorporated in its(their) entirety by reference herein.

### TECHNICAL FIELD

Aspects of the disclosure generally relate to systems and methods for microthruster arrays.

### BACKGROUND

Microthrusters are small thrusters capable of producing micronewtons of force.

### SUMMARY

A microthruster array system may include a package housing configured to receive circuitry and a propellant housing, a nozzle plate configured to close the package housing and ensure element ignition, the propellant housing arranged between the nozzle and the package housing and configured to house propellant for use in propulsion of the microthruster, and wherein the nozzle plate defines a plurality of openings for controlling a flow of the propellant during propulsion.

In one example, the plurality of openings are defined by the nozzle plate form a square of equally spaced openings.

In one embodiment, wherein the plurality of openings form a 16 by 16 array for 256 cells.

In another example, a flex circuit is arranged within the package housing and configured to provide control for the microthruster.

In one example, the flex circuit includes a plurality of resistive igniters configured to initiate combustion.

In another example, the propellant housing is configured to encapsulate the flex circuit within the package housing and defines a propellant housing opening at each corner thereof.

In one embodiment, the package housing defines a package housing opening each corner thereof, each package housing opening configured to align with a corresponding propellant housing opening, where upon aligned, the corresponding openings are configured to receive a fastener to attach the propellant housing to the package housing and seal the flex circuit therebetween.

In another embodiment, the propellant housing and flex circuit are further attached via a first adhesive.

In one example, a diaphragm is arranged between the nozzle and the propellant housing.

In another example, the diaphragm is formed of aluminum.

In one embodiment, the diaphragm is attached to each the nozzle and the propellant housing via an adhesive.

In another embodiment, the package housing includes sides extending upwards from a base.

In one example, one of the sides defines a slot for receiving a flex cable connected to a flex circuit arranged within the package housing.

In another example, the flex cable includes a connector and stiffener external to the package housing.

A method for arranging a microthruster array system may include receiving circuitry and a propellant housing in a package housing, closing the package housing via a nozzle plate to ensure element ignition, wherein the propellant housing is arranged between the nozzle and the package housing and configured to house propellant for use in propulsion of the microthruster, and wherein the nozzle plate defines a plurality of openings for controlling a flow of the propellant during propulsion.

In one example, the method includes arranging a flex circuit within the package housing to provide control for the microthruster.

In another example, the flex circuit includes a plurality of resistive igniters configured to initiate combustion.

In one embodiment, the propellant housing is configured to encapsulate the flex circuit within the package housing and defines a propellant housing opening at each corner thereof.

In another embodiment, the package housing defines a package housing opening at each corner thereof, and further comprising aligning each package housing opening with a corresponding propellant housing opening to receive a fastener to attach the propellant housing to the package housing and seal the flex circuit therebetween.

In one example, the method includes arranging a diaphragm between the nozzle and the propellant housing.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a perspective view of an example microthruster.

FIG. 2 illustrates a side view of the microthruster of FIG. 1.

FIG. 3 illustrates a bottom view of the microthruster of FIG. 1.

FIG. 4A illustrates another top view of an example housing and nozzle of the microthruster of FIG. 1.

FIG. 4B illustrates a bottom view of the example housing of the microthruster 100 of FIG. 1.

FIG. 4C illustrates example igniter resistors.

FIG. 5 illustrates an exploded view of the example microthruster of FIG. 1.

FIG. 6A illustrates a bottom view of an example flex circuit and nozzle of FIG. 5. prior to integration into package housing.

FIG. 6B illustrates a top view of an example flex circuit and nozzle of FIG. 5. prior to integration into package housing.

FIG. 7 illustrates a block diagram of an example microthruster system of FIG. 5 for controlling the microthruster.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Microthrusters are a type of propulsion system designed for smaller aircrafts or satellites. These propulsions may be used to adjust the trajectory of the satellite and often used where larger propulsion systems are too robust.

Disclosed herein is a microthruster and microthruster array that provide propulsion. The microthruster includes a housing, circuitry, adhesive, propellant housing, and nozzle. In one example, the array may measure 16×16 mm, have 256 cells with 0.0585″ (1.5 mm) center-to-center spacing, and is capable of producing impulse energy of 250+/−50 uN/sec. Table 1 below list example specification for the example microthruster.

TABLE 1

| Characteristic | Requirement |
|---|---|
| Active Array Size | 16 × 16 |
| Impulse Energy | 250 +/− 50 uN-sec |
| Firing Control | 4 in quick succession |
| Electrical Interface | Serial Protocol, 3.3 |
| | VDC Power |
| Engineering Units Delivered | 28 Flight Electrical 3 in |
| | housings, 1 flat flex |
| Mechanical Interface | 4 Mounting Holes, Max Volume |
| | 0.3064 cubic inches |
| Tested Firing Temp Range | −40 to +80 C |
| Power Consumption | 5 mJ to fire one cell |

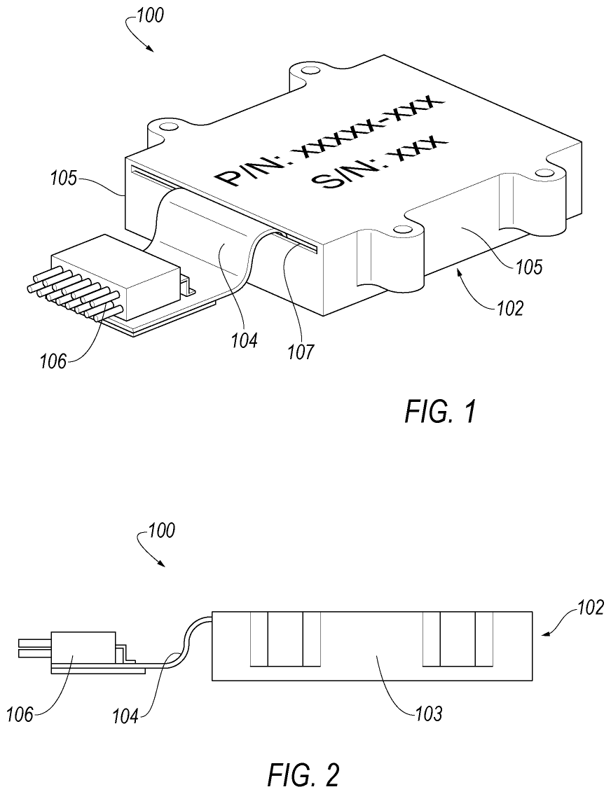

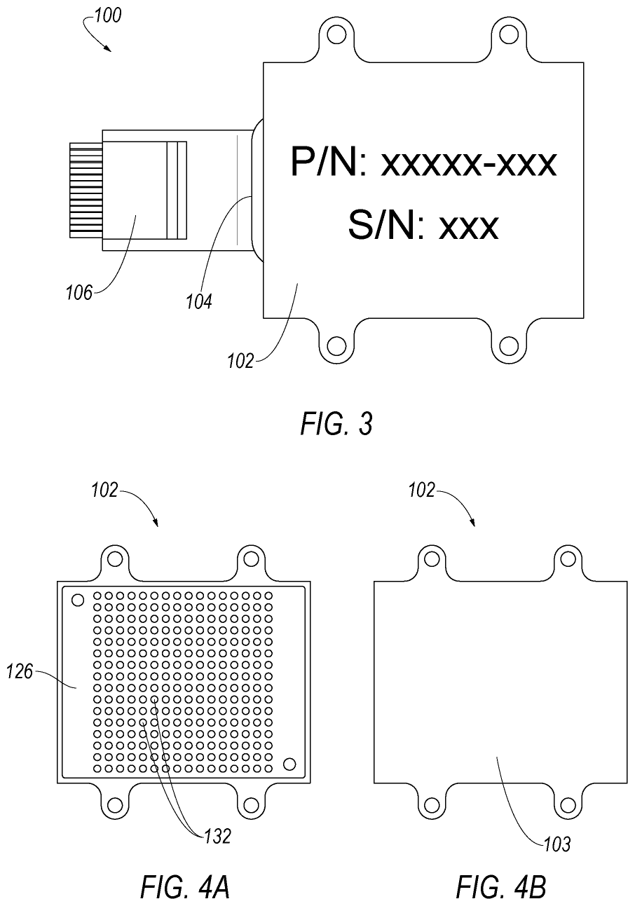

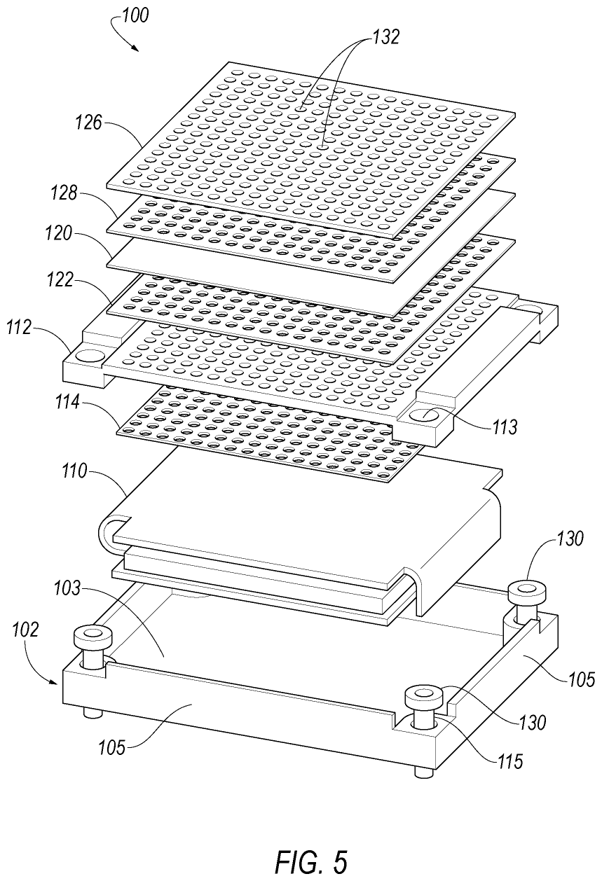

FIG. 1 illustrates a perspective view of an example microthruster 100. FIG. 2 illustrates a side view of the microthruster 100 of FIG. 1. FIG. 3 illustrates a bottom view of the microthruster of FIG. 1. The microthruster 100 may include a package housing 102 and a flex circuit/cabling 104 extending at least partially therefrom. The package housing 102 may form a quadratic or cubical shape having a base 103 and four sides 105 extending upward from the base 103. At least one of the sides 105 defines a slot 107 configured to receive the flex cabling 104. The flex cabling 104 may be attached to a flex circuit (illustrated in FIG. 5) within the housing 102 at one end a connector 106 external to the housing at another end. The connector 106 may be small and durable and capable of performing in various environments. In this example the connector 106 may be an OMNETICS connector. A stiffener (not individually labeled), may be arranged at the connector 106. Alternatively, the connector 106 can be rigidly mounted to the housing 102 without the need for an external flex circuit/cabling 104.

Within the housing the cabling 104 may be connected to a flex circuit. The flex cabling may include conductive material that allows the circuit and cabling to bend and conform to different shapes. The flex circuit may be lightweight and thin and allow for flexible assembly. The flex circuit may serve as the electrical connector between various components of the microthruster.

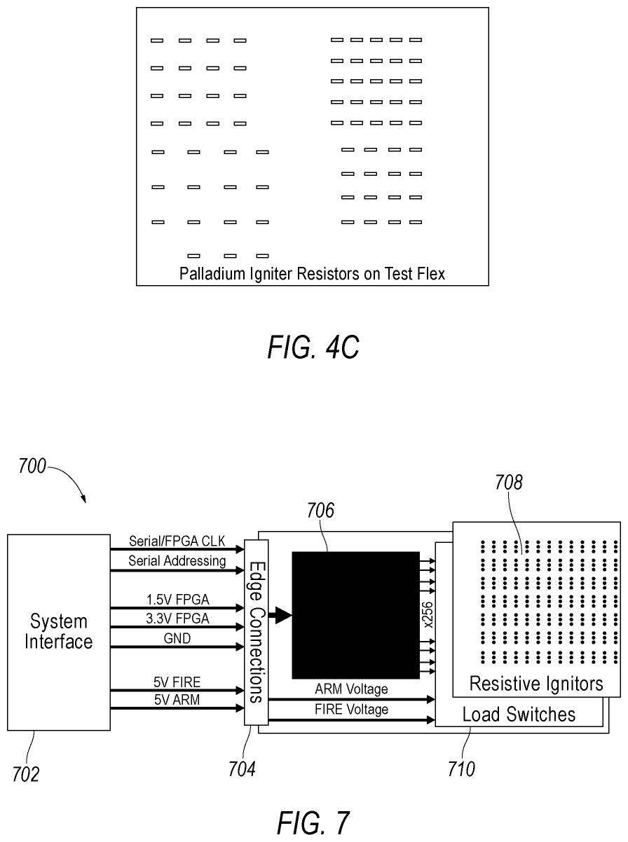

FIG. 4A illustrates another top view of an example housing 102 and nozzle or nozzle plate 126 of the microthruster 100 of FIG. 1. The nozzle 126 may be designed to control the flow of propellant during propulsion. The nozzle 126 is designed to maximize efficiency for the microthruster.

The nozzle 126 described herein may form a plurality of openings 132. The nozzle 126 may be formed of a metallic material, and in one example may be stainless steel. The housing may be formed of the same material. The openings 132 may form a grid-like pattern and may each be of similar dimensions and shape. For example, each opening may be square-like. Alternatively, the openings may be circular. In the example shown in FIG. 4A, the openings 132 may form a 16×16 grid of equally spaced openings 132 to facilitate a 256 element array. Other shapes, sizes and patterns may be appreciated.

FIG. 4B illustrates a bottom view of the example housing 102 of the microthruster 100 of FIG. 1.

FIG. 4C illustrates example igniter resistors included in the flex circuit. Such resistors may initiate combustion by heating up to a high temperature when electrical current passes through the resistor.

FIG. 5 illustrates an exploded view of the example microthruster 100 of FIG. 1. The microthruster 100 may include the package housing 102 which forms the bottom or base 103 and at least portions of the sides 105. A flex circuit 110 is arranged in the package housing 102 and attached to a propellant housing 112 via a first adhesive 114. The flex circuit 110 may attached to the flex cable 104 of FIG. 1, or may be part of the flex cable 104. The flex circuit 110 may be received and fit within the housing 102.

The propellant housing 112 may store propellant used to generate thrust. The propellant may be in the form of liquid, gas or solid. In some example, the propellant housing 112 may store the propellant under certain pressure and may manage heat generated during propulsion. The housing 112 may be formed of metal such as aluminum, stainless steel, titanium, etc. In some examples, the housing 112 may be formed of a ceramic. The propellant housing 112 may be formed to extend and cover the flex circuit 110 arranged there below. In the example shown in FIG. 5, the propellant housing 112 defines a propellant housing opening 113 at each corner thereof.

The package housing 102 may define a package housing opening 115 at each corner thereof, each configured to align with a corresponding propellant housing opening 113. When aligned, a fastener 130 may be arranged at each corner of the package housing 102 and configured to extend through the openings 113, 115 to attach the package housing 102 to the propellant housing 112.

A diaphragm, such as an aluminum piece, or sheet of foil 120 may be arranged on the propellant housing 112 opposite the side adjacent the flex circuit 110. The foil 120 may be attached to the propellant housing 112 via a second adhesive 122. The foil 120 may be flexible membrane type of element configured to aid in controlling the flow of the propellant in combination with the nozzle 126. The foil may also aid in separating the propellant from other components, as well as act as a pressure regulator. While described as foil, other materials may be used such as ceramics. The nozzle 126 may cap the housing 102 and attach to the foil 120 via a third adhesive 128.

The adhesives 114, 122, 128 may include a glue, tape, resin, plastics, epoxy, polyurethane or polymer, acrylic, hot melt, foam, solder, to name a few. The adhesives 114, 122, 128 may be similar or different, and may include a combination of various adhesives and methods.

Example specifications for the components illustrated in FIG. 5 are listed below in Table.

TABLE 2
Mechanical Assembly Stack-Up

| | |
|---|---|
| Nozzle Plate | 0.031″ holes |
| | 0.020″ thick |
| Adhesive | Ablestik 550k |
| | 0.005″ thick |
| Diaphragm | Al Foil |
| | Un-anadoized |
| | <0.001″ thick |
| Adhesive | Ablestik 550k |
| | 0.005″ thick |
| Thruster Housing | 0.039″ holes |
| | 0.039 thick at igniters |
| | SST |
| Adhesive | Ablestik 550k |
| | 0.005″ thick |
| Flex | Polyimide |
| Package Base | SST |
| | 0.020″ external wall |

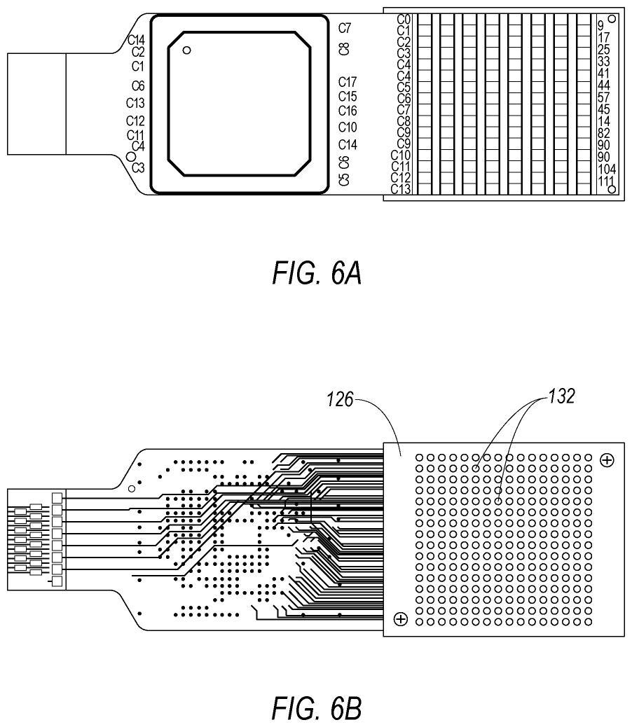

FIG. 6A illustrates a bottom view of an example flex circuit 110 and nozzle 126 of FIG. 5 prior to integration into package housing 102. FIG. 6B illustrates a top view of an example flex circuit 110 and nozzle 126 of FIG. 5. prior to integration into package housing 102.

FIG. 7 illustrates a block diagram of an example microthruster system 700 of FIG. 5 for controlling the microthruster. The microthruster system 700 may include various system interfaces configured to connect and control elements of the microthruster 100. The interface 702 may be configured to connect to edge connectors 704 to a field-programmable gate array (FPGA) 706, e.g., a programmable gate array. The FPGA 706 may provide the control algorithms for the microthruster to work effectively and efficiently such as resistive igniters 708, similar to the resistors illustrated in FIG. 4C, as well as various load switches 710 (such as N- or P-channel field effect transistors) or alternative addressing schemes.

The system interfaces 702 may require voltages for the I/O to supply proper current to the igniters 708. Proper element ignition is ensured via serial addressing. Power is delivered to individually selectable igniters in the element array.

The microthruster array design herein provides a robust microthruster that prevents a portion of the propellant from being ejected before it burns in the body, prevents ignitions of adjacent cells via shock waves, heat transfer, or alternative means of sympathetic ignition, protects the flex circuit from heat and pressure of burning propellant that could result in opens or shorts in the circuit traces, prevents resistor element failure before ignition, does not require specially formulated propellant grains or chemistry, prevents premature diaphragm rupturing, allows the necessary components to fit within the allocated housing volume.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A microthruster array system, comprising:
a package housing configured to receive circuitry and a propellant housing,
a nozzle plate configured to close the package housing and ensure element ignition,
the propellant housing arranged between the nozzle and the package housing and configured to house propellant for use in propulsion of the microthruster, and
wherein the nozzle plate defines a plurality of openings for controlling a flow of the propellant during propulsion

2. The system of claim 1, wherein the plurality of openings defined by the nozzle plate form a square of equally spaced openings.

3. The system of claim 2, wherein the plurality of openings form a 16 by 16 array for 256 cells.

4. The system of claim 1, further comprising a flex circuit arranged within the package housing and configured to provide control for the microthruster.

5. The system of claim 4, wherein the flex circuit includes a plurality of resistive igniters configured to initiate combustion.

6. The system of claim 4, wherein the propellant housing is configured to encapsulate the flex circuit within the package housing and defines a propellant housing opening at each corner thereof.

7. The system of claim 4, wherein the package housing defines a package housing opening each corner thereof, each package housing opening configured to align with a corresponding propellant housing opening, where upon aligned, the corresponding openings are configured to receive a fastener to attach the propellant housing to the package housing and seal the flex circuit therebetween.

8. The system of claim 7, wherein the propellant housing and flex circuit are further attached via a first adhesive.

9. The system of claim 7, further comprising a diaphragm arranged between the nozzle and the propellant housing.

10. The system of claim 9, wherein the diaphragm is formed of aluminum.

11. The system of claim 9, wherein the diaphragm is attached to each the nozzle and the propellant housing via an adhesive.

12. The system of claim 1, wherein the package housing includes sides extending upwards from a base.

13. The system of claim 12, wherein one of the sides defines a slot for receiving a flex cable connected to a flex circuit arranged within the package housing.

14. The system of claim 13, wherein the flex cable includes a connector and stiffener external to the package housing.

15. A method for arranging a microthruster array system, comprising:
receiving circuitry and a propellant housing in a package housing;
closing the package housing via a nozzle plate to ensure element ignition,
wherein the propellant housing is arranged between the nozzle and the package housing and configured to house propellant for use in propulsion of the microthruster, and wherein the nozzle plate defines a plurality of openings for controlling a flow of the propellant during propulsion.

16. The method of claim 15, further comprising arranging a flex circuit within the package housing to provide control for the microthruster.

17. The method of claim 16, wherein the flex circuit includes a plurality of resistive igniters configured to initiate combustion.

18. The method of claim 4, wherein the propellant housing is configured to encapsulate the flex circuit within the package housing and defines a propellant housing opening at each corner thereof.

19. The method of claim 4, wherein the package housing defines a package housing opening at each corner thereof, and further comprising aligning each package housing opening with a corresponding propellant housing opening to receive a fastener to attach the propellant housing to the package housing and seal the flex circuit therebetween.

20. The method of claim 15, further comprising arranging a diaphragm between the nozzle and the propellant housing.
